(19) United States
(12) Patent Application Publication
(10) Pub. No.: US 2021/0248617 A1
(43) Pub. Date: Aug. 12, 2021

(54) SYSTEM AND METHOD FOR PREDICTING SUPPORT ESCALATION

(71) Applicant: Intuit Inc., Mountain View, CA (US)

(72) Inventors: Andrew Mattarella-Micke, Menlo Park, CA (US); Pavlo Malynin, Menlo Park, CA (US); David S. Grayson, San Francisco, CA (US); Tianhao Luo, East Brunswick, NJ (US)

(73) Assignee: Intuit Inc., Mountain View, CA (US)

(21) Appl. No.: 16/785,964

(22) Filed: Feb. 10, 2020

(51) Int. Cl. G06Q 30/00; G06N 3/08; G06F 17/18; G06Q 30/02; H04L 29/08

(52) U.S. Cl. CPC G06Q 30/016; G06N 3/08; H04L 67/22; G06Q 30/0281; G06F 17/18

(57) ABSTRACT

A method and system train an analysis model with a machine learning process to predict whether a current user of the data management system will contact customer assistance agents of the data management system. The machine learning process utilizes historical clickstream data indicating actions taken by a plurality of historical users of the data management system while using the data management system. The analysis model predicts whether the current user will contact customer assistance agents by analyzing current clickstream data associated with the current user.

### BACKGROUND

People utilize data management systems to assist in managing various types of data. For example, data management systems assist users to manage bookkeeping, tax return preparation, financial transactions, and budgeting. Data management systems enable users to electronically manage these matters in a way that reduces the amount of time and resources users spend managing their personal data.

Users of data management systems occasionally encounter problems or questions related to the use of the data management systems. Typically, users can resolve these problems by accessing self-help solutions provided by the data management systems. However, in some cases, users are not able to resolve their problems with the self-help solutions provided by the data management systems.

When other solutions fail, users of data management systems often attempt to contact assistance personnel of the data management systems. For example, users may make a telephone call to an assistance service of the data management systems in order to speak to a customer assistance agent, email a customer assistance agent, or enter into an instant message chat with a customer assistance agent. The customer assistance agent can then help resolve the problem or question of the user.

What is needed is a method and system that provides a technical solution to the problem of detecting when users are likely to contact assistance agents.

### SUMMARY

Embodiments of the present disclosure provide one or more technical solutions to the problem of detecting when users are likely to contact assistance agents. Embodiments of the present disclosure analyze the way historical users of a data management system have interacted with the data management system in the past, as well as whether or not those historical users contacted assistance agents. Embodiments of the present disclosure use this analysis to determine if a current user is likely to contact assistance agents.

Embodiments of the present disclosure utilize machine learning processes to predict when users of the data management system will contact assistance agents. Embodiments of the present disclosure gather historical user data including, for each of a plurality of historical users, clickstream data and data indicating whether the historical user contacted assistance agents. Embodiments of the present disclosure generate training set data from historical user data. The training set data includes the clickstream data and label data indicating whether the historical users contacted assistance agents. The machine learning process trains an analysis model to predict whether users of the data management system will contact assistance agents based on the clickstream data and the labeled data.

Embodiments of the present disclosure overcome many of the drawbacks of traditional customer assistance processes and systems. Intelligently identifying when a user is likely to request assistance based on clickstream data utilizes significantly less human and computing resources in providing customer assistance to users.

### BRIEF DESCRIPTION OF THE DRAWINGS

FIG. 1 is a flow diagram of a process for training an analysis model to predict whether users will contact assistance agents, in accordance with one embodiment.

FIG. 2 is a flow diagram of a process for predicting whether users will contact assistance agents, in accordance with one embodiment.

FIG. 3 is a block diagram of a data management system, in accordance with one embodiment.

FIG. 4 is a flow diagram of a process for efficiently providing assistance to users of a data management system, in accordance with one embodiment.

FIG. 5 is a flow diagram of a process for efficiently providing assistance to users of a data management system, in accordance with one embodiment.

Common reference numerals are used throughout the FIGs and the detailed description to indicate like elements. One skilled in the art will readily recognize that the above FIGs are examples and that other architectures, modes of operation, orders of operation, and elements/functions can be provided and implemented without departing from the characteristics and features of the invention, as set forth in the claims.

### DETAILED DESCRIPTION

Embodiments will now be discussed with reference to the accompanying FIGs, which depict one or more exemplary embodiments. Embodiments may be implemented in many different forms and should not be construed as limited to the embodiments set forth herein, shown in the FIGs, and described below. Rather, these exemplary embodiments are provided to allow a complete disclosure that conveys the principles of the invention, as set forth in the claims, to those of skill in the art.

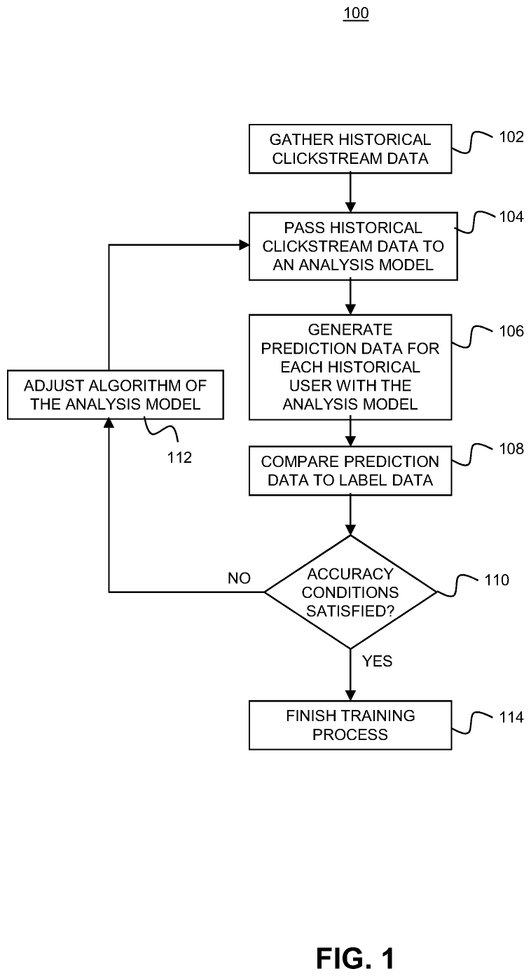

FIG. 1 is a flow diagram of a process 100 for training an analysis model with a machine learning process, according to one embodiment. As will be set forth in more detail below, the machine learning process trains the analysis model to be able to predict whether a current user of the data management system will access assistance agents. If the data management system can reliably detect when the users will contact assistance agents, the data management system can take actions to improve the effectiveness and efficiency of customer assistance. Additionally, the data management system can take steps to address user concerns before the users contact assistance agents.

At 102, the process 100 gathers historical clickstream data. The historical clickstream data includes data reflecting selections made by historical users while accessing the data management system. The historical clickstream data can indicate how the historical users have navigated through the data management services and products provided by the data management system. The historical clickstream data can include selections made by the historical users, data management screens visited by the historical users, data management products or services accessed or purchased by the historical users, searches performed by the historical users, self-help resources accessed by the historical users, and other kinds of actions taken by the historical users in relation to the data management system.

In one example, the data management system includes a tax return preparation system. The historical clickstream data includes the selections made by the historical users and the actions taken by the historical users in utilizing the tax return preparation system. The historical clickstream data can include tax topics accessed by the historical users, tax forms uploaded or filled out by the historical users, tax related self-help resources accessed by the historical users, payments made by the historical users, tax returns filed by the historical users, tax return preparation screens or webpages accessed by the historical users, and other types of actions taken by the historical users in relation to the tax return preparation system.

In one embodiment, the historical clickstream data is sequential historical clickstream data. In other words, for a given historical user, the historical clickstream data indicates the sequence of the various actions taken by the historical user while accessing the products or services of the data management system. As will be described in more detail below, the sequence of events in the historical clickstream data can be leveraged to provide reliable predictions as to whether users will attempt to contact assistance agents.

In one embodiment, the historical clickstream data indicates whether the historical users have contacted assistance agents associated with a customer assistance system of the data management system. An attempt to contact assistance agents is recorded in the historical clickstream data as an action taken by the historical users. The historical clickstream data can indicate whether historical users attempted to contact the assistance agents by phone, by email, by an instant messenger service, or in another way. The historical clickstream data can indicate a number of times that historical users contacted assistance agents. The historical clickstream data can indicate lengths of time between contacts with assistance agents. The historical clickstream data can indicate if an assistance issue was resolved, a product or service associated with an attempt to contact assistance agents. The historical clickstream data can indicate whether or not the historical user was a paid subscriber or a trial user of the data management system. The historical clickstream data can include other call-specific and historical user-specific features.

In one example, the data management system is a bookkeeping system. In this case, a historical user can correspond to a company or business that utilizes the bookkeeping system. In this case, the training set data can include data indicating how long the company has used to bookkeeping system, whether a payroll service of the data management system is used by the company, or other aspects related to companies that access the data management system.

In one embodiment, the historical clickstream data includes, for each historical user, an aggregation of clickstream data over selected period of time. In one example, the period of time is three months, though other periods of time for clickstream data aggregation can be utilized without departing from the scope of the present disclosure.

The clickstream data is split into two groups. The first group corresponds to historical users that contacted assistance agents during the aggregation period. The second group corresponds to historical users that did not contact assistance agents during the aggregation period. The historical clickstream data indicates, for each historical user, whether the historical user contacted assistance agents. Accordingly, the division of the historical users into the two groups is performed automatically and not by experts or other professionals dividing into the groups by hand.

The dividing of the historical users into the two groups corresponds to the type of labeling. The label for each historical user indicates whether the historical user contacted assistance agents or did not contact assistance agents. The labeling is used during the machine learning process, as is described in more detail below.

In one embodiment, the historical clickstream data for single historical user is represented by a sequence of vectors. Each vector represents an action taken by the historical user. Accordingly, each action and type of action is represented by a particular vector. Thus, in one embodiment, there is a vocabulary of clickstream actions. Each clickstream action is represented by a particular vector representation. Thus, the historical clickstream data for a historical user can be represented by a sequence of vectors.

At 104, the historical clickstream data is passed to the analysis model. The analysis model analyzes the historical clickstream data and generates, for each historical user associated with the historical clickstream data, a prediction indicating whether or not that historical user contacted assistance agents.

In one embodiment, the analysis model is a deep neural network. The deep neural network is sensitive to the sequence of actions taken by the historical users in the historical clickstream data. The deep neural network can include a plurality of hidden layers. The deep neural network can include a convolutional neural network, a recurrent neural network, or a transformer neural network. Each of these types of neural networks can be sensitive to the sequence of data in the historical clickstream data for a given historical user. Other types of analysis models can be utilized without departing the scope of the present disclosure

In one embodiment, the historical user data for each historical user is fed to the analysis model as a sequence of vectors. The sequence of vectors corresponds to the sequence of actions taken by the historical user during the aggregation period. The historical clickstream data for each historical user is fed to the analysis model in this manner.

In one embodiment, the historical user data for each historical user is fed to the analysis model is a matrix made up of the sequence of vectors. Accordingly, the historical clickstream data for each historical user is a matrix. The matrix retains the sequential aspect of the historical clickstream data.

In one embodiment, the matrix for each historical user can be compressed prior to passing the matrix to the analysis model. The compression of the matrix can reduce the matrix from a sparse high dimensional matrix to a dense low dimensional matrix. The initial matrix is sparse because a majority of the data fields are empty or populated by zeros. The compressed matrix is dense because the number of dimensions is reduced and fewer of the data fields are unpopulated or populated by zeros.

At 106, the process 100 generates prediction data for each historical user with the analysis model. Accordingly, after the historical clickstream data is passed to the analysis model, the analysis model generates prediction data for each historical user. The prediction data indicate whether or not the historical user contacted assistance agents during the aggregation period.

The analysis model processes, for each historical user, the historical clickstream data. This can correspond to processing the sequence of vectors or the matrix representing the sequence of actions in the historical clickstream data. In particular, the historical clickstream data is passed through the various neural network layers. The output of the final neural network layer is a prediction regarding whether or not the historical user accessed assistance agents during the aggregation period.

At 108, the process 100 compares the prediction data to the labeled data. The labeled data corresponds to the groups into which the historical users were separated prior to processing. The process 100 checks to determine what percentage of the predictions matched the labels. In other words, the process 100 compares the prediction made for each historical user, to the known grouping or label for that historical user.

In one embodiment, accuracy conditions are set for the machine learning process. The training process is complete when the accuracy conditions are satisfied. The accuracy conditions can include a threshold accuracy percentage or a threshold for another type of accuracy metric. The accuracy condition can correspond to a situation in which the accuracy of the analysis model no longer improves after several iterations of the machine learning process.

At 110, process 100 determines whether or not the accuracy conditions are satisfied. If the accuracy conditions are not satisfied, then the process proceeds to 112. If the accuracy conditions are satisfied and the process proceeds to 114.

At 112 the process 100 adjusts the algorithm of the analysis model. The algorithm can be adjusted by altering an arrangement of neural networks, by altering weights associated with aspects of the analysis model, by altering a prediction function of the analysis model, or by altering other parameters or configurations that affect the predictions made by the analysis model. From 112, the process 100 returns to 104. Steps 104, 106, and 108 are repeated. At 110 if the accuracy conditions are satisfied, the process proceeds to 114. If the accuracy conditions are not satisfied, then the algorithm of the analysis model is adjusted again at 112 and the process repeats itself. This machine learning process continues in iterations until the accuracy conditions are satisfied.

At 114 if the accuracy conditions are satisfied, the machine learning process for the analysis model is complete. The analysis model can now be utilized to reliably predict whether or not a current user of the data management system will contact assistance agents. Those of skill in the art will recognize, in light of the present disclosure, that other machine learning models can be utilized in accordance with principles of the present disclosure, without departing from the scope of the present disclosure.

In one embodiment, the historical users can be divided into a set of groups based on a topic or driving factor of a call to the assistance agents. The analysis model, or a separate analysis model, can be trained in the manner described above to sort the historical users into categories based on the topics of their calls to the assistance agents. Accordingly, the data management system can utilize multiple analysis models for predicting whether a call will be made to assistance agents, and for predicting a topic of a call to an assistance agent. Knowing the topic of the call to the assistance agent can be useful in determining how best to prevent the call or to address the call.

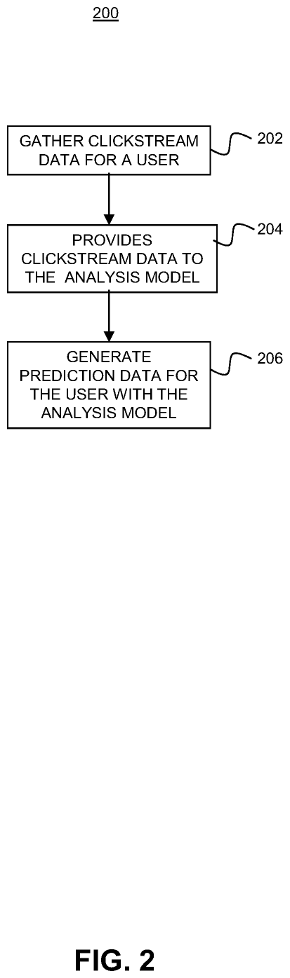

FIG. 2 is a flow diagram of a process 200 for predicting whether a user of a data management system will contact assistance agents, according to one embodiment. At 202, clickstream data is gathered for the user. The clickstream data may be considered current clickstream data for current user for whom a prediction is to be made. The clickstream data for the user can be aggregated over a period of time corresponding to the period of time for which the historical clickstream data was aggregated for training the analysis model as described in relation to FIG. 1. The clickstream data for the user corresponds to the actions taken by the user with the data management system during the aggregation period. The clickstream data can be compiled into the same format as the historical clickstream data was. For example, the clickstream data for the user can include a series of vectors, a matrix, or a compressed matrix.

At 204, the process 200 provides the clickstream data to the analysis model. The clickstream data is provided to the analysis model in the same format as was the historical clickstream data during the training of the analysis model.

At 206, the process 200 generates prediction data for the user with the analysis model. The clickstream data for the user is processed by the analysis algorithm of the analysis model as described in relation to FIG. 1. The analysis model generates a prediction as to whether the user is likely to contact assistance agents. The output of the analysis model can be a probability score between 0 and 1 indicating a probability that the user will contact assistance agents. Alternatively, the output of the analysis model is thresholded into a binary output indicating whether or not the user is predicted to contact an agent.

If the prediction data indicate that the user is likely to contact assistance agents, then the user is a candidate for intervention by the data management system. Intervention can include emailing an offer for assistance to the user, providing a message via the data management system while the user is utilizing the data management system, having an assistance agent contact the user, or providing self-help topics or other content to the user to alleviate a concern before the user contacts assistance agents.

In one embodiment, the analysis model generates a prediction as to the topic of the likely assistance call. The data management system can take various actions to assist the user prior to the user contacting assistance agents based on the predicted topic. The data management system can make an intervention as described above, including providing specific data related to the topic via email, in product messaging, promotional offerings, direct contact from an assistance agent, or in other ways.

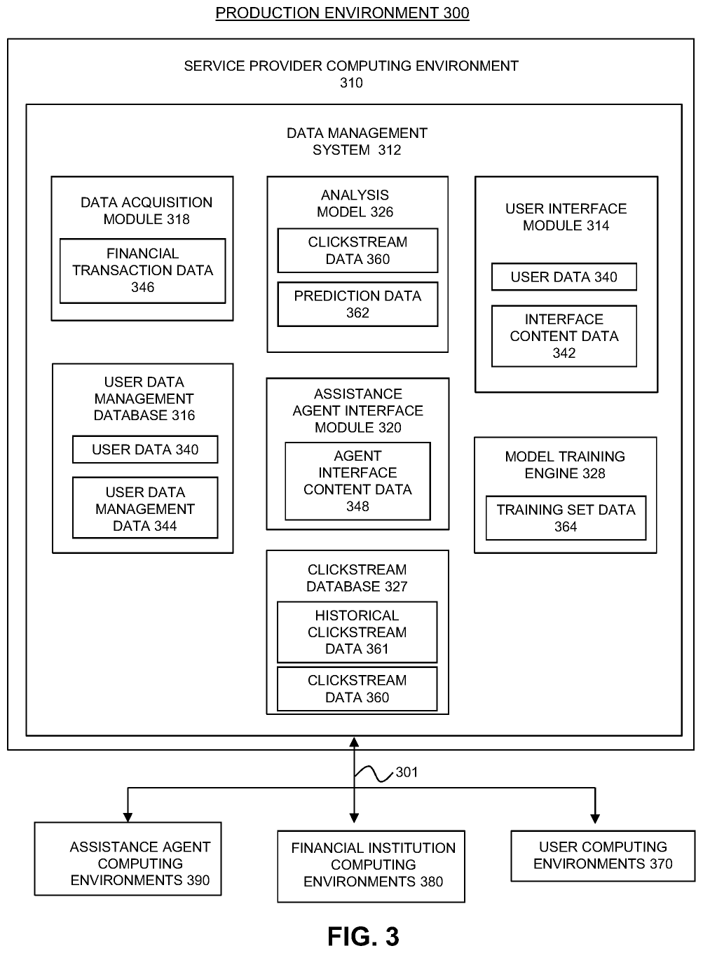

FIG. 3 illustrates a block diagram of a production environment 300 for efficiently providing assistance to users of a data management system, according to one embodiment. The production environment 300 includes a service provider computing environment 310, user computing environments 370, financial institution computing environments 380, and assistance agent computing environments 390, for providing secure and effective support to users of a data management system, according to various embodiments. The computing environments 310, 370, 380, and 390 are communicatively coupled to each other with one or more communication channels 301, according to one embodiment.

The service provider computing environment 310 represents one or more computing systems such as a server or distribution center that is configured to receive, execute, and host one or more data management systems (e.g., applications) for access by one or more users, for providing secure and effective support to users of a data management system, according to one embodiment. The service provider computing environment 310 represents a traditional data center computing environment, a virtual asset computing environment (e.g., a cloud computing environment), or a hybrid between a traditional data center computing environment and a virtual asset computing environment, according to one embodiment.

The service provider computing environment 310 includes a data management system 312, which is configured to provide data management services to users. According to one embodiment, the data management system 312 can be a system that manages one or more of book-keeping, accounting, banking, investments, loans, credit cards, real estate investments, retirement planning, bill pay, and budgeting. The data management system 312 can be a tax return preparation system or other type of data management system. The data management system 312 can be a standalone system that provides data management services to users. Alternatively, the data management system 312 can be integrated into other software or service products provided by a service provider.

As the data management system 312 provides data management services to users, it is possible that users will have questions or problems regarding use of the data management system 312. In these cases, it is possible that the users will decide to contact a user assistance system or user assistance agent of the data management system 312 in order to answer the questions or resolve the problems. The data management system 312 provides a framework and system that enables assistance agents to provide effective assistance to the users.

The data management system 312 includes a user interface module 314, a user data management database 316, a data acquisition module 318, an assistance agent interface module 320, an analysis model 326, a clickstream database 327, and a model training engine 328, according to various embodiments.

The user computing environments 370 correspond to computing environments of the various users of the data management system 312. The users of the data management system 312 utilize the user computing environments 370 to interact with the data management system 312. The users of the data management system 312 can use the user computing environments 370 to provide data to the data management system 312 and to receive data, including data management services, from the data management system 312.

In one embodiment, the data management system 312 can provide data management services to individuals, businesses, organizations, government entities, groups of individuals, or any other entities for which data management services would be beneficial, according to one embodiment. Individuals may utilize the data management system 312 to track their own revenues and expenditures. Businesses of all kinds, including large corporations, midsize companies, small businesses, or even sole proprietor businesses, can utilize the data management system 312 to track and sort their financial transactions as a way to better manage their finances. Likewise, government organizations may use the data management system 312 to track various types of expenditures and revenues. Organizations other than businesses and government entities, such as nonprofit organizations, may also utilize the data management system 312 for the purpose of monitoring and sorting expenditures and revenues. Thus, the term “user” can refer to many types of entities.

Returning to the data management system 312, the user interface module 314 is configured to receive user data 340 from the users, according to one embodiment. The user data 340 can include, for each user, information, such as, but not limited to, a first name of the user, a surname of the user, a date of birth of the user, a data management system user identification, a government identification number such as a driver's license number or a Social Security number, a date of birth of the user, a phone number of the user, demographics data associated with the user, a type of account that the user has with the data management system, an address of the user, authentication data that enables the user to access the data management system 312, data related to bank accounts of the user, credit card accounts of the user, loan accounts of the user, investments of the user, or other types of data that a user may provide in working with the data management system 312, according to various embodiments.

In one embodiment, the user data 340 can include account data corresponding to financial institution authentication data that enables the data management system 312 to access the financial accounts that the user has with third-party financial institutions or other third-parties. In one embodiment, the financial institution authentication data provided by the users as part of the user data 340 enables the data management system 312 to acquire information related to financial transactions of the users. The financial institution authentication data can include data that allows the data management system 312 to gain access to credit card data, bank account data, retirement fund data, payroll data, income data, loan data, interest accrual data, student loan data, property ownership data, tax data, budgeting data, rent data, investments data, employment data, or other types of data regarding financial transactions or financial accounts of the users. Thus, the financial institution authentication data can include login credentials and personal identification data for various websites of third-party financial institutions. The financial institution authentication data can include usernames, passwords, bank account numbers, routing numbers, credit card numbers, answers to security questions, identification numbers, government identification numbers, birth dates, addresses, or other types of verification credentials that allow the data management system 312 to gain access to online services of third-party financial service institutions.

According to an embodiment, the user interface module 314 provides interface content data 342 to assist the user in managing the user's data. The interface content data 342 can include navigation menus and other graphical user interface (GUI) tools that enable the user to navigate the data management system 312 in order to receive data management services. The interface content data 342 can include financial management data related to the financial transactions of the user. Thus, the user interface module 314 enables the data management system 312 to provide financial management services to the user.

In one embodiment, the data management system 312 includes a user data management database 316. The user data management database 316 includes the user data management data 344. The user data management data 344 can include data management data for all of the users of the data management system. Thus, the user data management database 316 can include a vast amount of data related to the data management services provided to users. In one embodiment, when the user utilizes the user interface module 314 to view interface content data 342, the interface content data 342 includes user data management data 344 related to the user as retrieved from the user data management database 316.

In one embodiment, the user data management data 344 includes financial management data of the users. The financial management data can include data related to the financial transactions of the users. The user data management data 344 can include, for each user, a list of financial transactions, summaries of various financial accounts, and other tools to assist the user in managing the user's finances. The user data management data 344 can include financial reports received, retrieved, or generated by the data management system 312

In one embodiment, the data management system 312 provides data management services other than financial management services. Accordingly, the user data management data 344 can include data other than financial management data.

In one embodiment, the data management system 312 utilizes the data acquisition module 318 to retrieve financial transaction data 346 related to the financial transactions of the users of the data management system 312. The data acquisition module 318 is configured to use the financial institution authentication data provided with the user data 340 to acquire financial transaction data 346 related to financial transactions of the users. In particular, the data acquisition module 318 uses the financial institution authentication data received with the user data 340 to log into the online services of third-party financial institutions in order to retrieve financial transaction data 346 related to the financial transactions of users of the data management system 312. For example, the financial transaction data 346 can include debit card transactions, credit card transactions, credit card balances, bank account deposits, bank account withdrawals, credit card payment transactions, online payment service transactions such as PayPal transactions or other online payment service transactions, loan payment transactions, investment account transactions, retirement account transactions, mortgage payment transactions, rent payment transactions, bill pay transactions, budgeting information, financial goal information, or any other types of financial transactions. The data acquisition module 318 is configured to gather the financial transaction data from financial institution computing environments 380 related to financial service institutions with which one or more users of the data management system 312 have a relationship. The financial transaction data 346 can include, for each financial transaction, time stamp data corresponding to a time stamp that indicates the date and time of the financial transaction.

In one example, the data acquisition module 318 uses the financial institution authentication data received with the user data 340 to acquire data related to withdrawals, deposits, and balances in the bank accounts of users. The financial transaction data 346 includes data related to these withdrawals, deposits, and balances. Accordingly, the financial institution authentication data can include usernames, passwords, bank account numbers, routing numbers, or other validation credentials needed to access online services of various banking institutions.

In one embodiment, the data management system 312 utilizes the data acquired by the data acquisition module 318 to assist users in managing their finances. For example, the data management system 312 can utilize the data acquired by the data acquisition module 318 to generate reports and summaries of the users' financial data or other types of data to assist the user and easily viewing and ascertaining the history and current status of the users' financial data or other kinds of data.

In some cases, users of the data management system 312 may require assistance in resolving a question, concern, or problem related to the services provided by the data management system 312. Accordingly, the data management system 312 retains user assistance agents to help resolve the questions or concerns of the users. In one embodiment, the assistance agents can include customer support personnel that receive phone calls, instant messages, or other communications from users of the data management system 312 and assist the users to resolve their questions or problems.

In one embodiment, the data management system 312 utilizes the assistance agent interface module 320 to enable assistance agents to provide support to users of the data management system 312. When the data management system 312 assigns an assistance agent to assist a user, the assistance agent can interface with the assistance agent interface module 320. When the assistance agent interfaces with the assistance agent interface module 320, the assistance agent interface module 320 provides agent interface content data 348 to the assistance agent. The assistance agent utilizes the agent interface content data 348 to assist the user to resolve the question or problem of the user.

In one embodiment, the assistance agent computing environments 390 correspond to computing environments utilized by assistance agents to interface with the data management system 312 and/or to communicate with the user computing environments 370. The assistance agent computing environments 390 include computing resources utilized by the assistance agents to access the data management system 312 in order to provide assistance to the users. The computing resources can include processing resources, memory resources, communication resources, and computing devices by which the assistance agents interface with the assistance agent interface module 320.

In one embodiment, the assistance agent computing environments 390 are part of the data management system 312. In this case, the computing resources and devices utilized by the assistance agents can include computing devices and applications owned, controlled, or otherwise operated by the data management system 312.

In one embodiment, the data management system 312 utilizes the analysis model 326 to determine whether a user of the data management system is likely to contact assistance agents. In particular, the data management system 312 utilizes machine learning processes by which the analysis model 326 learns to identify when users are likely to contact assistance agents. In particular, the analysis model 326 receives clickstream data 360 associated with a user of the data management system 312 and generates prediction data 362. The prediction data can indicate whether or not the user is likely to contact assistance agents, based on the clickstream data 360. The prediction data can also indicate a likely topic that will drive the user to contact assistance agents.

In one embodiment, the data management system 312 includes the clickstream database 327. The clickstream database 327 includes historical clickstream data 361 and clickstream data 360. The historical clickstream data 361 includes clickstream data associated with historical users of the data management system, as described in relation to FIG. 1. The clickstream data 360 includes clickstream data associated with a current user of the data management system, as described in relation to FIG. 2.

The model training engine 328 trains the analysis model 326 with one or more machine learning processes, such as those described in relation to FIG. 1. The model training engine 328 generates training set data 364. The training set data 364 includes the historical clickstream data 361 processed and formatted to be provided to the analysis model 326, as described in relation to FIG. 1. The training set data 364 can include labeled data that corresponds to the grouping of historical users into groups defining whether or not the historical users contacted assistance agents during an aggregation period of the historical clickstream data 361. The training set data can also include grouping or labels identifying a topic of assistance calls made by historical users. After the model training engine 328 has generated the training set data 364, the model training engine 328 trains the analysis model 326 with the machine learning processes as described in relation to FIG. 1.

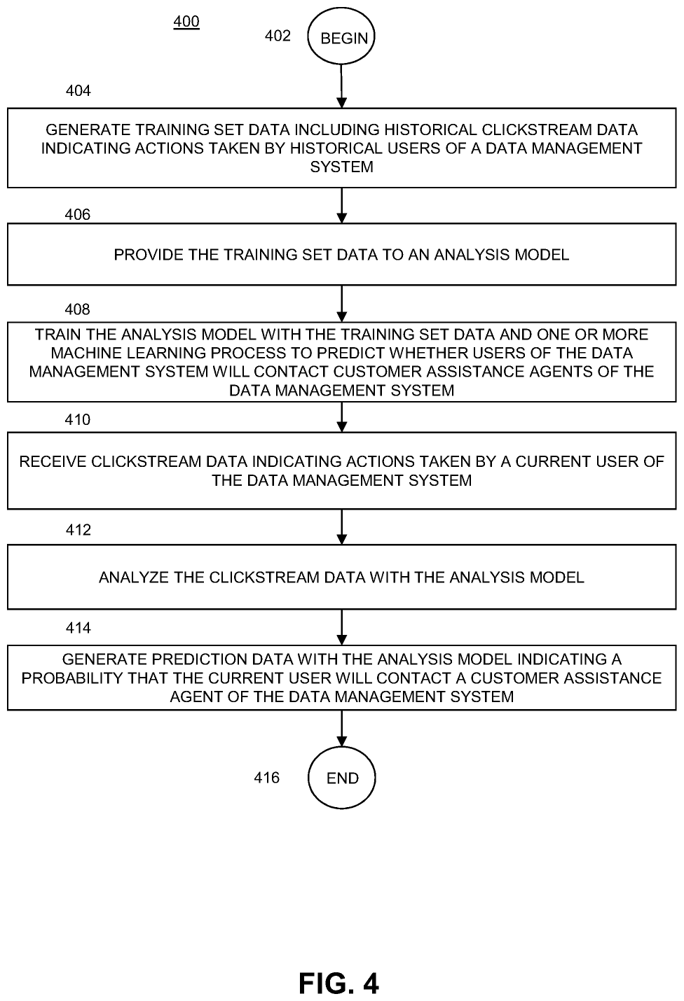

FIG. 4 illustrates a flow diagram of a process 400 for efficiently providing assistance to users of a data management system, in various embodiments.

Referring to FIG. 4, FIGS. 1-2, and the description of FIGS. 1-2 above, in one embodiment, 402 the process begins. At 404 the process includes generating training set data including historical clickstream data indicating actions taken by historical users of a data management system, using any of the methods, processes, and procedures discussed above with respect to FIGS. 1-3

At 406, the process includes providing the training set data to an analysis model, using any of the methods, processes, and procedures discussed above with respect to FIGS. 1-3.

At 408, the process includes training the analysis model with the training set data and one or more machine learning process to predict whether users of the data management system will contact customer assistance agents of the data management system, using any of the methods, processes, and procedures discussed above with respect to FIGS. 1-3

At 410, the process includes receiving clickstream data indicating actions taken by a current user of the data management system, using any of the methods, processes, and procedures discussed above with respect to FIGS. 1-3

At 412, the process includes analyzing the clickstream data with the analysis model, using any of the methods, processes, and procedures discussed above with respect to FIGS. 1-3.

At 414, the process includes generating prediction data with the analysis model indicating a probability that the current user will contact a customer assistance agent of the data management system, using any of the methods, processes, and procedures discussed above with respect to FIGS. 1-3.

In one embodiment, at 416 the process ends.

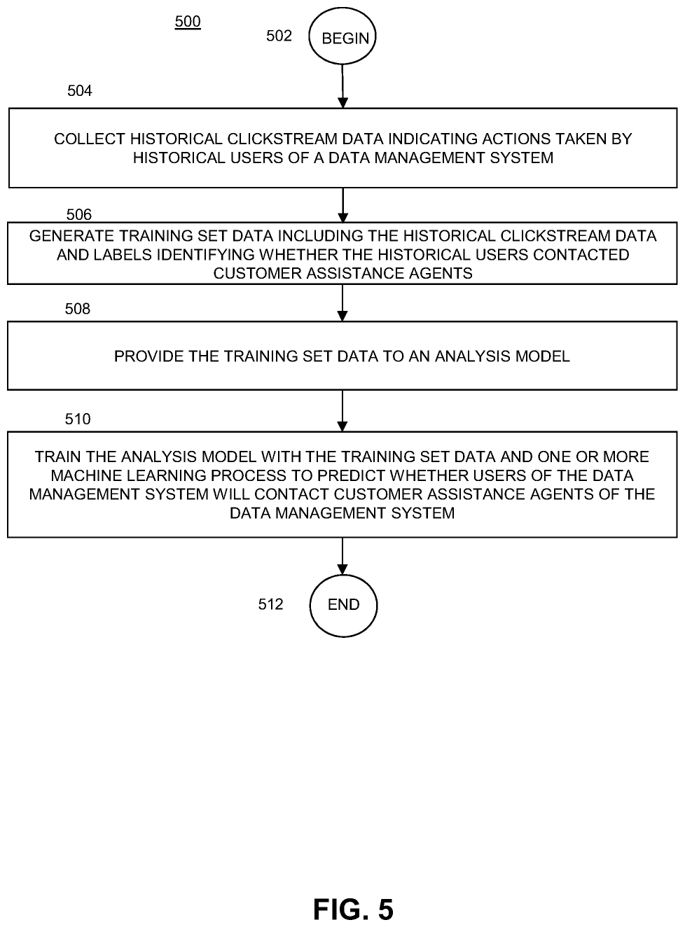

FIG. 5 illustrates a flow diagram of a process 500 for efficiently providing assistance to users of a data management system, in various embodiments.

Referring to FIG. 5, FIGS. 1-2, and the description of FIGS. 1-2 above, in one embodiment, 502 the process begins. At 504 the process includes collecting historical clickstream data indicating actions taken by historical users of a data management system, using any of the methods, processes, and procedures discussed above with respect to FIGS. 1-3

At 506, the process includes generating training set data including the historical clickstream data and labels identifying whether the historical users contacted customer assistance agents, using any of the methods, processes, and procedures discussed above with respect to FIGS. 1-3.

At 508, the process includes providing the training set data to an analysis model, using any of the methods, processes, and procedures discussed above with respect to FIGS. 1-3

At 510, the process includes training the analysis model with the training set data and one or more machine learning process to predict whether users of the data management system will contact customer assistance agents of the data management system, using any of the methods, processes, and procedures discussed above with respect to FIGS. 1-3

In one embodiment, at 512 the process ends.

As noted, the specific illustrative examples discussed above are but illustrative examples of implementations of embodiments of the method or process for efficiently providing assistance to users of a data management system. Those of skill in the art will readily recognize that other implementations and embodiments are possible. Therefore, the discussion above should not be construed as a limitation on the claims provided below.

In one embodiment a method includes generating training set data including historical clickstream data indicating actions taken by historical users of a data management system and providing the training set data to an analysis model. The method includes training the analysis model with the training set data and one or more machine learning process to predict whether users of the data management system will contact customer assistance agents of the data management system and receiving clickstream data indicating actions taken by a current user of the data management system. The method includes analyzing the clickstream data with the analysis model and generating prediction data with the analysis model indicating a probability that the current user will contact a customer assistance agent of the data management system.

In one embodiment, a system includes at least one processor and at least one memory device coupled to the processor. The memory device, having stored therein instructions which, when executed by any set of the one or more processors, will perform a process. This process includes training an analysis model using one or more machine learning processes to predict whether users of the data management system will contact customer assistance agents of the data management system based on historical clickstream data indicating actions taken by a plurality of historical users of the data management system. The process further includes receiving clickstream data indicating actions taken by a current user of the data management system, analyzing the clickstream data with the analysis model, generating prediction data with the analysis model indicating a probability that the current user will contact a customer assistance agent of the data management system.

In one embodiment a method includes collecting historical clickstream data indicating actions taken by historical users of a data management system and generating training set data including the historical clickstream data and labels identifying whether the historical users contacted customer assistance agents. The method includes providing the training set data to an analysis model and training the analysis model with the training set data and one or more machine learning process to predict whether users of the data management system will contact customer assistance agents of the data management system.

It should also be noted that the language used in the specification has been principally selected for readability, clarity and instructional purposes, and may not have been selected to delineate or circumscribe the inventive subject matter. Accordingly, the disclosure of the present invention is intended to be illustrative, but not limiting, of the scope of the invention, which is set forth in the claims below.

In addition, the operations shown in the FIGs, or as discussed herein, are identified using a particular nomenclature for ease of description and understanding, but other nomenclature is often used in the art to identify equivalent operations.

Therefore, numerous variations, whether explicitly provided for by the specification or implied by the specification or not, may be implemented by one of skill in the art in view of this disclosure.

What is claimed is:

1. A method, comprising:
generating training set data including historical clickstream data indicating actions taken by historical users of a data management system;
providing the training set data to an analysis model;
training the analysis model with the training set data and one or more machine learning processes to predict whether users of the data management system will contact customer assistance agents of the data management system;
receiving clickstream data indicating actions taken by a current user of the data management system;
analyzing the clickstream data with the analysis model; and
generating prediction data with the analysis model indicating a probability that the current user will contact a customer assistance agent of the data management system.

2. The method of claim 1, wherein the analysis model includes a deep neural network.

3. The method of claim 2, wherein the analysis model is sensitive to a sequence of the clickstream data.

4. The method of claim 3, wherein the analysis model includes one or more of:
a convolutional neural network;
a recurrent neural network; and
a transformer neural network.

5. The method of claim 1, wherein the prediction data includes a predicted topic about which the current user is likely to contact a customer assistance agent.

6. The method of claim 1, wherein the clickstream data includes a sequence of vectors, each vector corresponding to an action taken by the user in relation to the data management system.

7. The method of claim 1, wherein the clickstream data includes a matrix.

8. The method of claim 1, wherein the training set data identifies, for each historical user, whether or not the historical user contacted assistance agents.

9. The method of claim 1, wherein the training set data includes labels indicating, for each historical user, whether or not the historical user contacted assistance agents.

10. The method of claim 9, wherein the machine learning process is a supervised machine learning process utilizing the labels.

11. A method, comprising:
collecting historical clickstream data indicating actions taken by historical users of a data management system;
generating training set data including the historical clickstream data and labels identifying whether the historical users contacted customer assistance agents;
providing the training set data to an analysis model; and
training the analysis model with the training set data and one or more machine learning process to predict whether users of the data management system will contact customer assistance agents of the data management system.

12. The method of claim 11, wherein training the analysis model includes training the analysis model to reproduce the labels for each historical user.

13. The method of claim 12, wherein generating training set data includes selecting historical clickstream data from a selected aggregation period.

14. A system, comprising:
at least one processor; and
at least one memory coupled to the at least one processor, the at least one memory having stored therein instructions which, when executed by any set of the one or more processors, perform a process including:
training an analysis model one or more machine learning process to predict whether users of the data management system will contact customer assistance agents of the data management system based on historical clickstream data indicating actions taken by a plurality of historical users of the data management system;
receiving clickstream data indicating actions taken by a current user of the data management system;
analyzing the clickstream data with the analysis model; and
generating prediction data with the analysis model indicating a probability that the current user will contact a customer assistance agent of the data management system.

15. The system of claim 14, wherein the analysis model includes a deep neural network.

16. The system of claim 15, wherein the analysis model is sensitive to a sequence of the clickstream data.

17. The system of claim 16, wherein the analysis model includes one or more of:
a convolutional neural network;
a recurrent neural network; and
a transformer neural network.

18. The system of claim 14, wherein the prediction data includes a predicted topic about which the current user is likely to contact a customer assistance agent.

19. The system of claim 14, wherein the clickstream data includes a sequence of vectors, each vector corresponding to an action taken by the user in relation to the data management system.

20. The system of claim 14, wherein the clickstream data includes a matrix.
